(19) United States
(12) Patent Application Publication
(10) Pub. No.: US 2003/0101941 A1
(43) Pub. Date: Jun. 5, 2003

(54) Feeding system

(76) Inventor: Johannes M W Weelink, Vries (NL)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(21) Appl. No.: 10/182,060

(22) PCT Filed: Nov. 26, 2001
(86) PCT No.: PCT/NL01/00860

(30) Foreign Application Priority Data
Nov. 24, 2000 (NL) 1016707

(51) Int. Cl. A01K 1/10; A01K 5/00; A01K 39/00

(52) U.S. Cl. 119/51.01

(57) ABSTRACT

The invention relates to an apparatus for placing in a stall to dispense fodder to animals in the stall in controlled manner, which apparatus includes a foot and a superstructure on the foot, which foot has a broad base on the side directed toward a floor of the stall for stability during use, and is formed from elements which can be assembled in situ in the stall.

The present invention relates to an apparatus intended for placing in a stall to dispense fodder to animals in the stall in controlled manner, which apparatus comprises a foot and a superstructure on the foot.

Such apparatuses are generally known. They are used as feeding fences and feeding slides.

The feeding fences are used with head holes therein so that animals such as cows can reach through the head holes to fodder, this fodder being placed in front of the feeding fence. A feeding slide can be used to push up toward the feeding fence quantities of fodder placed in front of the feeding fence when this latter is in stationary position. In this way the fodder is pushed gradually toward the stationary feeding fence. The animals or cows can take up the fodder subject to the speed at which the feeding slide pushes up the fodder. In a configuration wherein the feeding fence is displaced and is not in stationary position, the use of the feeding slide may be unnecessary, but this is not always the case. The displaceable feeding fence is released for a movement over a predetermined distance per unit of time, so that the consumption of fodder by the animals is controlled in this way.

A main drawback of such apparatus is that they are fully produced by, among other methods, welding different elements to each other. It is particularly the case that, because the foot of such apparatus must be broad on the underside for stabilizing purposes, such fully produced apparatuses are bulky in transport.

Another drawback is that welding together the elements of the apparatus, in particular the foot, has the result that a rigid system is placed which is not very flexible. If there is any variation in the dimensions other than those for which a relevant apparatus is produced in advance, the whole apparatus must be removed and produced again for the correct dimensions, which involves a further two additional transport actions.

The present invention is based on the insight that a solution for the above stated problems must be provided, for which purpose an apparatus according to the present invention is distinguished in that this apparatus, in particular the foot thereof, is formed from elements which can be assembled in situ in the stall. Owing to the invention, wherein the elements of particularly the foot of such an apparatus are assembled in situ, considerable space is saved during transport and a greater degree of flexibility is provided during assembly in respect of dimensioning and variations in the anticipated dimensions. A feeding system is generally provided which is easier to produce, easier to transport and which is also cheaper, partly though not solely, due to these factors.

The present invention has diverse preferred embodiments as defined in the dependent claims.

It is thus possible to implement the main concept of the invention as stated above in that the foot comprises at least two types of prefabricated, substantially plate-like components. The plates can then be per se stacked and preferably even stacked in nested manner, so that considerable space is saved compared with a fully assembled apparatus. Transport costs are thus also saved. The plate-like components are preferably designed so as to be nestable per type. This achieves that the elements are also sorted when assembly of the apparatus begins.

The measure is preferably applied that the different types of plate-like component are offset relative to each other in the foot in the assembled situation. A relation is thus created in the foot of such an apparatus which is comparable to the brickwork in a mortar wall. Thus realized is that the strength and robustness of the foot are so great that further structural measures can be deemed substantially unnecessary. This does not however preclude the possibility of further structural measures being taken within the scope of the present invention for further strengthening of the foot.

When assembled the foot can have a triangular cross-section, which is an advantageous embodiment particularly in respect of strength and robustness. At least one strengthening rib can further be arranged in the interior of the foot. Such a strengthening rib can be considered a further structural measure to increase the strength or robustness. This is particularly the case when the strengthening rib extends substantially in a direction transversely of the length direction of the foot in the assembled situation. This is further the case particularly when the plate-like components extend substantially in length direction of the foot, so that the strengthening ribs forms a cross bracing in the interior of the foot with which the different plate-like components are fixed relative to each other by the strengthening ribs.

As described above for feeding fences and feeding slides, the foot of an apparatus according to the present invention can also comprise a drive. Such a drive can be placed in the interior of the foot, wherein the space therein is utilized for this purpose. Means can also extend through the foot to cause synchronous functioning of diverse moving parts at diverse locations along the length of the foot, so that oblique positioning of such an apparatus when it is displaced is effectively prevented.

Finally, the present invention also relates to a method for producing apparatus according to the present invention. The essence hereof is that elements suitable for this purpose are assembled in situ in the stall. In a special preferred embodiment hereof, use can be made of tools such as assembly stands to facilitate in situ assembly. Such assembly stands can be used as suspension point for a superstructure, wherein the foot is assembled on the underside of the superstructure from the components and elements to be assembled in situ.

The invention will be further elucidated hereinbelow with reference to a number of embodiments. In the drawing:

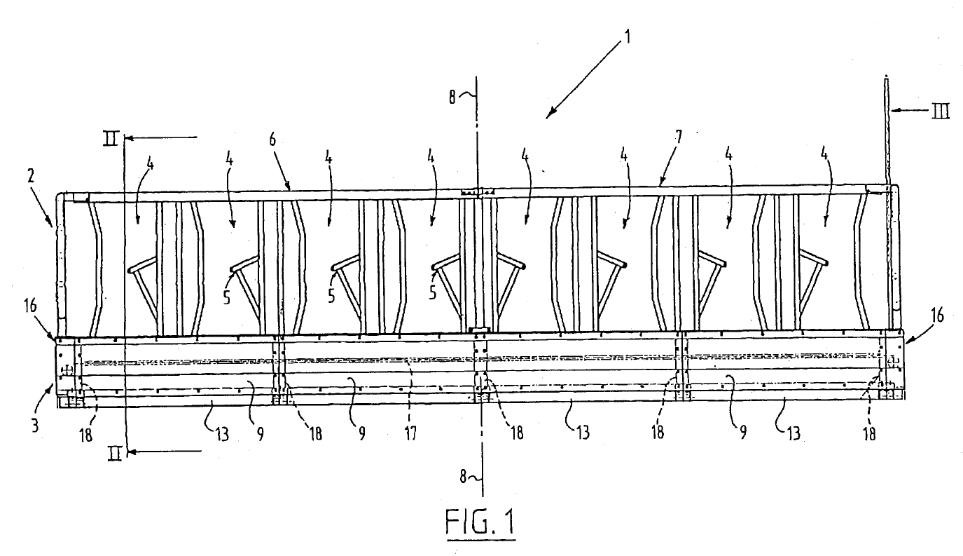

FIG. 1 shows a schematic front view of a displaceable feeding fence according to the present invention;

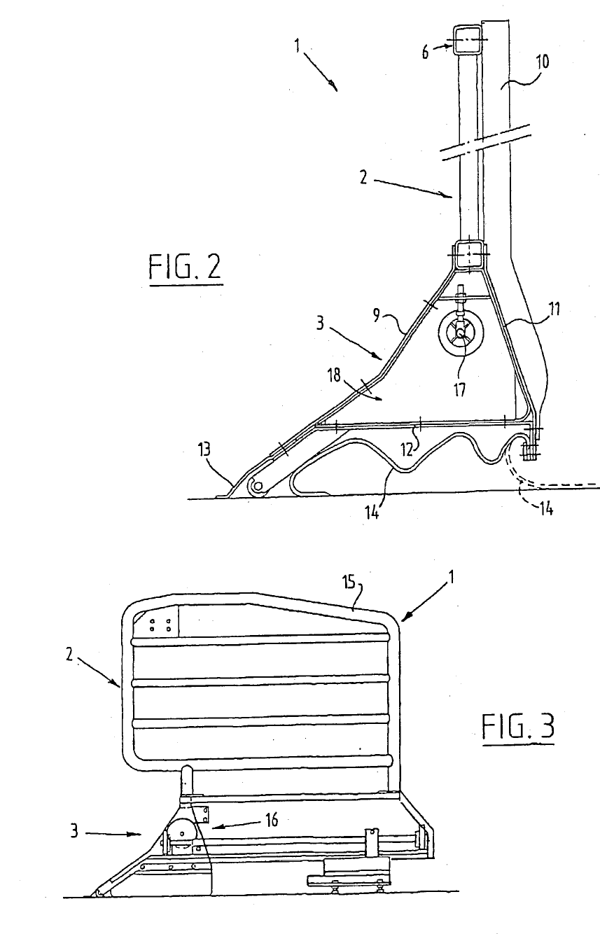

FIG. 2 is a cross-sectional view along the line II-II of the feeding fence shown in FIG. 1;

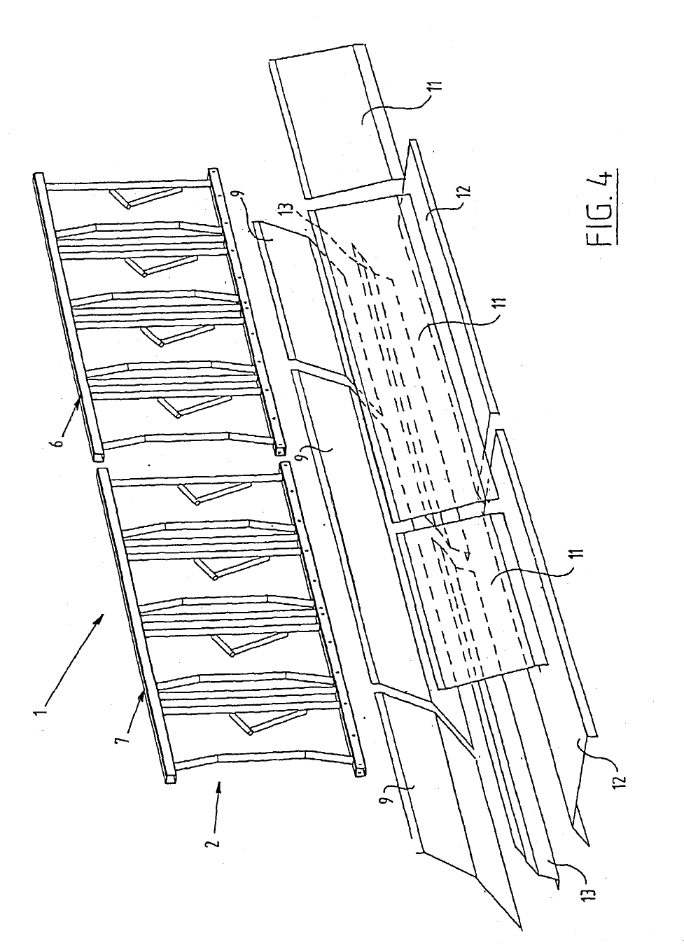

FIG. 3 is a side view in the direction of arrow III in FIG. 1;

FIG. 4 shows a schematic exploded perspective view of the feeding fence of FIG. 1;

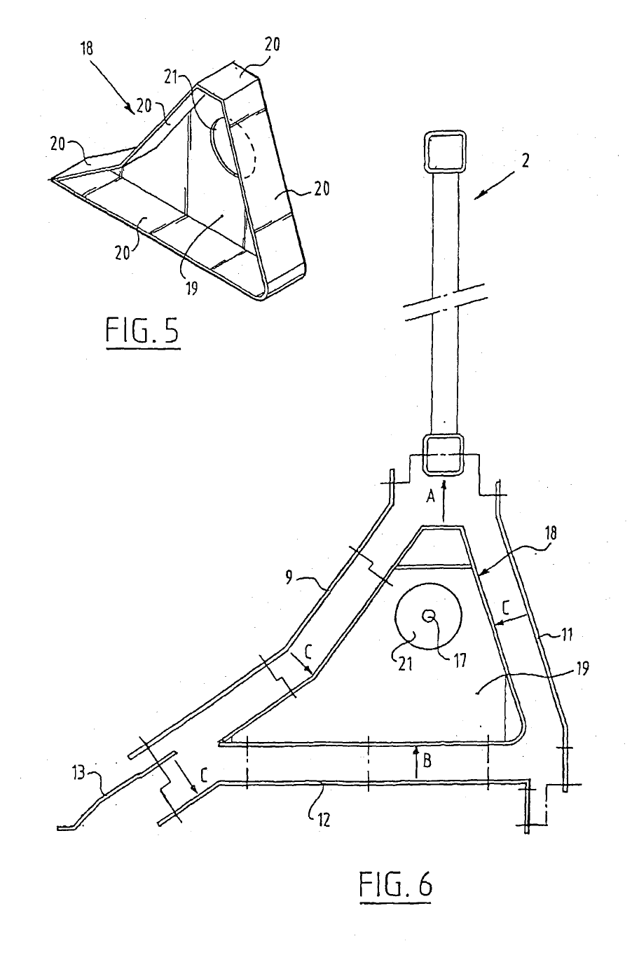

FIG. 5 is a perspective view of a strengthening rib which can be applied in an apparatus according to the present invention;

FIG. 6 shows a schematic side view of the manner in which the strengthening rib can be incorporated into an apparatus according to the present invention;

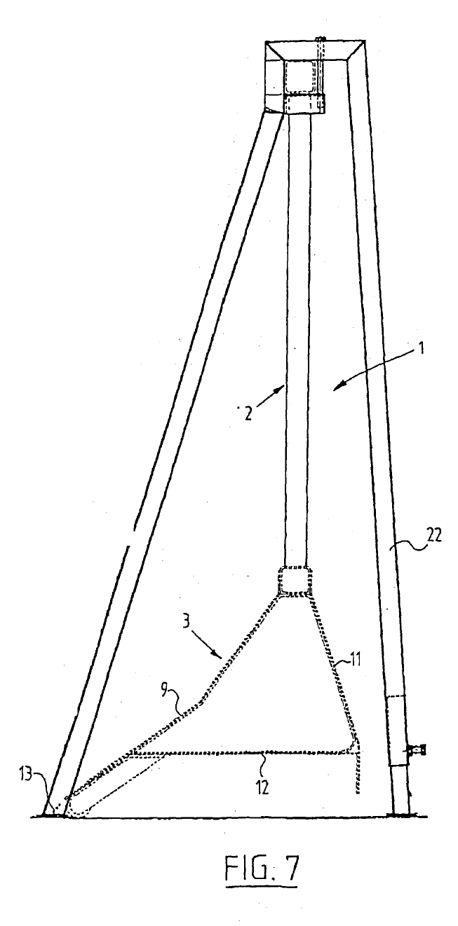

FIG. 7 shows an assembly stand which can be used to assemble an apparatus according to the present invention; and

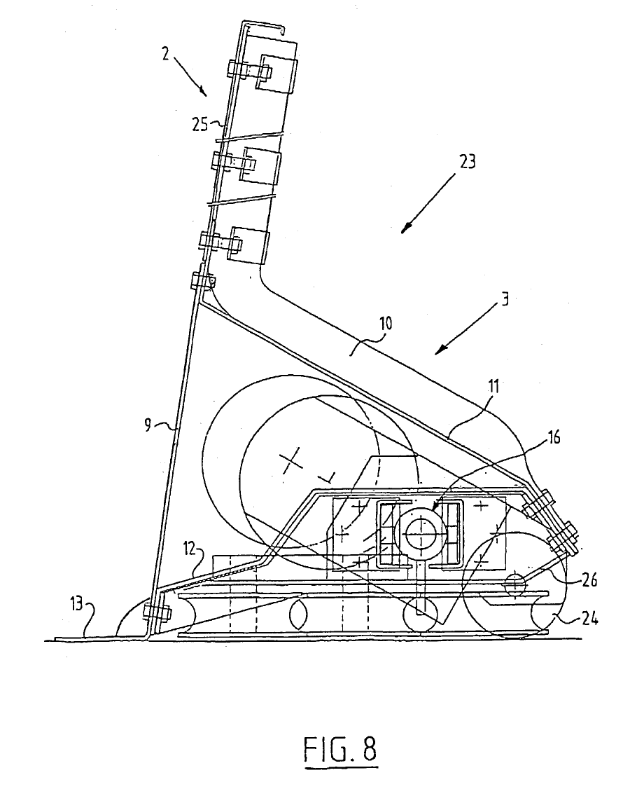

FIG. 8 shows a schematic side view of another apparatus according to the present invention, viz. a feeding slide

FIG. 1 shows a front view of an apparatus according to the present invention in the form of a feeding fence 1. Feeding fence 1 comprises a superstructure 2 which is arranged on a foot 3. The superstructure comprises a number of head holes 4 through which animals, in particular cows, can reach to the fodder which in practice is placed in front of the feeding fence in a stall. Not shown in FIG. 1 is that in practice swivel bars are mounted in head holes 4; only the supports 5 on which these swivel bars can be mounted are shown.

FIG. 1 shows clearly that in the embodiment shown here the superstructure comprises a left-hand fence 6 and a right-hand fence 7. Fences 6, 7 are in principle the same and have a substantially equal length. In the embodiment shown here the left-hand fence 6 and right-hand fence 7 are placed in mirror arrangement relative to the centre line 8 of feeding fence 1.

The foot 3 of feeding fence 1 comprises three front plates 9, the middle one of which has the same width as fences 6, 7, and the left-hand and right-hand front plates 9 have substantially half the width thereof. The middle front plates 9 therefore extend over centre line 8, and it will be apparent that front plates 9 and fences 6, 7 of superstructure 2 are mutually offset. This increases the sturdiness of foot 3 in the situation assembled with the other components of the fence, namely superstructure 2.

As shown in FIG. 2, foot 3 is triangular in cross-section. The sturdiness of the foot is hereby also increased. For this purpose the foot 3 is provided with a rear plate 11; a base plate 12: and a scraper plate 13 in addition to front plate 9. Further extending along rear plate 11 and superstructure 2 on the rear side of feeding fence 1 are uprights 10 with which an additional sturdiness is imparted to the assembly in vertical direction.

The method of assembly, the result of which is shown in FIG. 2 in the assembled state, will be further described hereinbelow. It is noted that, as shown in FIG. 4, rear plates 11 are offset in the same manner as front plates 9 in relation to left-hand fence 6 and right-hand fence 7 of superstructure 2 in order to form an offset relation, while base plates 12 are not offset relative to left-hand fence 6 and right-hand fence 7 in the assembly. Fences 6, 7 and base plates 12 thus form combinations which are not offset relative to each other in lengthwise direction of feeding fence 1, just as rear plates 11 and front plates 9 are not, while the combinations 9; 11 and 6, 7; 12 are offset relative to each other in longitudinal direction of feeding fence 1. A strong assembly is thus obtained.

Referring back to FIG. 2, it is noted that a rubber mat 14 is used under feeding fence 1 when the feeding fence in FIG. 2 is slidable to the left and back. The situation of rubber mat 14 in the position of feeding fence 1 displaced furthest to the right in FIG. 2 is shown in full lines, while the situation of rubber mat 14 in the position displaced furthest to the left in FIG. 2 is shown in dashed lines. In this manner the floor in front of and under feeding fence 1 is kept clean, wherein excreta from the animals is collected on the rubber mat.

FIG. 3 again shows feeding fence 1 in side view of FIG. 1 in the direction of arrow II. In longitudinal direction of feeding fence 1 an end fence 15 is mounted on one side. Arranged in the vicinity thereof is a drive 16 with which the whole feeding fence 1 can be displaced to the left in the figure as more of the fodder is consumed by the animals on the left-hand side of the fence. Alternatively, the movement to the left in FIG. 3 can be released in uniform steps through time, and the drive 16 can serve to return feeding fence 1 to the starting position once it has reached the position displaced furthest to the left in FIG. 3, this starting position corresponding with the position of feeding fence 1 displaced furthest to the right. Within the scope of the present invention it is not important whether the drive 16 is used to shift the feeding fence forward to the left or to move it back to the right as in FIGS. 2 and 3. If, as shown in FIG. 1, drives 16 are used at both ends of feeding fence 1, it is however important that means for synchronizing the two drives can extend through the foot 3 of the feeding fence. In the embodiment shown in FIG. 1 a shaft 17 is provided with which the drives 16 are coupled and synchronized. Such a shaft 17 may also be useful when drive 16 comprises a single motor and shaft 17 serves to transmit the motive power of the motor to moving parts at both outer ends of feeding fence 1. Many other embodiments are likewise possible within the scope of the present invention.

FIG. 2 further shows that between front plates 9, rear plates 11 and base plates 12 is arranged a strengthening rib designed as support 18. This is shown in more detail in FIG. 5. It is noted that this support 18 is optional. Support 18 is formed from a plate, the side edges of which are bent such that the shape thereof corresponds with the interior space in cross-section of foot 3. The central part of support 18 is designated with reference numeral 19, and this has the said shape of the interior space of foot 3. The bent parts of support 16 further form stop flanges 20, against which the front plates 9, rear plates 11 and base plates 12 can be mounted. This can take place in simple manner, as shown in FIG. 2, with nut-bolt connections, although rivets can alternatively be used, or even strong pop rivets. Other connecting means are also possible within the scope of the present invention.

It is further noted that in the central part 19 of support 18 there is formed a hole 21 through which can extend the above described shaft 17 for synchronizing the driving at both ends of feeding fence 1.

As shown in FIG. 6, the front plates 9, rear plates 11, base plates 12 and scraper plates 13 can be put together or integrally assembled in the direction of the arrows shown in FIG. 6. As also shown in FIG. 7, an assembly stand 22 can be applied for this purpose. The superstructure 2 is herein suspended in assembly stand 22. Support 18 is,then placed in the desired orientation in the direction of arrow A in FIG. 6 against the underside of superstructure 2 and this superstructure 2 and support 18 are then fixed together. Base plates 12 are subsequently arranged against the underside of support 18 in the direction of arrow B and fixed at that position, whereafter the front plates 9 and rear plates 11 are placed against superstructure 2, support 18 and base plates 12 and respectively connected thereto in the direction of arrows C. It is noted that scraper plate 13 can be arranged in the direction of arrow D on a front plate 19 prior to mounting of front plates 19. It is further remarked that the assembly sequence depends in large measure on the pattern in which the different components in foot 3 have to be offset relative to each other in the assembled state. A random offset pattern can be chosen other than that explicitly described in the foregoing with reference to for instance FIG. 4.

FIG. 6 shows most clearly, particularly in side view, that front plates 9 have a form such that they are stackable. This may even be described as nestable. A stack of front plates 9 will therefore take up a minimal amount of space but be immediately ready for use for assembly purposes. The same applies to rear plates 11, which are in any case stackable These can however not necessarily be considered nestable, in contrast to base plates 12, which are more clearly nestable than front plates 9 and rear plates 11.

During transport the front plates 9 lie stacked on each other; rear plates 11 lie stacked on each other and base plates 12 lie stacked on each other, and it will be apparent that scraper plates 13 are also stackable or can be transported in stacked manner. This occupies markedly less space than the transport of a fully assembled apparatus as shown in side view in for instance FIG. 2.

FIG. 8 shows a feeding slide 23 as embodiment of an apparatus according to the present invention. The same or similar parts and components are designated herein with the same reference numerals. The term “front” indicates the direction in which fodder is placed in front of the animals, and the term “rear” is used to designate the side opposite this.

Feeding slide 23 of FIG. 8 has a number of notable differences from the embodiment of the other figures described in the foregoing. Front plate 9 and scraper plate 13 thus form a unit. The superstructure 2 is closed in feeding slide 23, so that fodder for the livestock cannot be pushed up over the upper edge of superstructure 2 and then drop down behind it. Further arranged at the rear side of feeding slide 23 is a running wheel 24 over which the feeding slide rolls at the rear, while the front side slides over the ground with the scraper plate 13 in contact with this ground.

A notable difference is the absence of the strengthening ribs in the form of supports 18. A force exerted on foot 3 of feeding slide 23, i.e. by the fodder for pushing up, will always be smaller than the forces to which feeding fence 1 of FIG. 1 is subjected by the animals when they reach through the head holes to the fodder placed in front of feeding fence 1. For this reason it is possible to suffice with front plates 9, rear plates 11, base plates 12 and closing plates 25 which close superstructure 2. This provides sufficient sturdiness. It is further remarked that a drive 16 is incorporated into feeding slide 23. For this purpose the base plate 12 is offset to a greater extent than is shown for instance in FIG. 2, in order to provide space for drive 16, So as not to reduce the rigidity of the construction, an additional base plate 26 is arranged which also provides a point of suspension for the wheel 24 over which feeding slide 23 rolls at the rear. As already remarked above, the manner in which drive 16 is designed is not of significance per se for the present invention, although here in FIG. 8 it is important that space can be made for such a drive 16 between base plate 12 and the additional base plate 26.

It will be apparent to a skilled person, after examination of the foregoing, that many alternative and additional embodiments are possible within the scope of the present invention, as this is defined solely by and limited to the appended claims. Different types of drive are thus possible, for instance with chains, cables, gear wheels, driven wheels etc. The patterns in which the different elements forming in combination an apparatus according to the present invention can further be offset in many other ways relative to each other than explicitly described above. In each of the described embodiments there is a so-called “half-half” relation, but it is also possible to work with a “one third-one third-one third” relation, and so on. Further described in the foregoing is a number of explicit, stackable and even nestable forms of the plates from which the foot of an apparatus according to the present invention is manufactured in situ, i.e. in a stall. The actual form of each type of plate is of course dependent upon the final desired form of the foot, but a skilled person will be able to modify and adjust this such that per type or mix of a number of types the plates for assembly are in any case stackable, and perhaps even nestable, for the purpose of facilitating transport.

1. Apparatus for placing in a stall to dispense fodder to animals in the stall in controlled manner, which apparatus comprises a foot and a superstructure on the foot, which foot has a broad base on the side directed toward a floor of the stall for stability during use, and is formed from elements which can be assembled in situ in the stall.

2. Apparatus as claimed in claim 1, wherein the foot comprises at least two types of prefabricated, substantially plate-like components.

3. Apparatus as claimed in claim 2, wherein the plate-like components are designed so as to be nestable prior to assembly of at least the foot.

4. Apparatus as claimed in claim 3, wherein the plate-like components are nestable per type.

5. Apparatus as claimed in at least one of the claims 2, 3 or 4, wherein the types of plate-like component are offset relative to each other in the foot in the assembled situation.

6. Apparatus as claimed in at least one of the claims 2-5, wherein the foot has a substantially triangular form in upright cross-section in the assembled state.

7. Apparatus as claimed in any of the foregoing claims, wherein at least one strengthening rib is arranged in the foot in the assembled state.

8. Apparatus as claimed in claim 7, wherein the strengthening rib extends substantially in a direction transversely of the length direction of the foot in the assembled state.

9. Apparatus as claimed in claim 1, wherein the superstructure comprises a number of head holes through which animals reach to fodder placed in front of the apparatus.

10. Apparatus as claimed in claim 1, wherein space in the foot is utilized to accommodate a drive for displacing the apparatus over a floor of the stall.

11. Apparatus as claimed in claim 10, wherein the drive comprises at least one motor and moving parts on the opposite ends of the foot, and wherein means extend through the interior of the foot to at least one of the moving parts for synchronization of the two moving parts.

12. Method for producing an apparat us as claimed in at least one of the foregoing claims, comprising of manufacturing a foot, manufacturing a superstructure for placing on the foot, wherein at least the manufacture of the foot comprises of: assembling elements for at least the foot in situ in the stall.

13. Method as claimed in claim 12, further comprising of stably suspending at least the superstructure from an assembly stand during assembly and assembling the foot starting from the superstructure.
